(19) United States
(12) Patent Application Publication
(10) Pub. No.: US 2018/0252849 A1
(43) Pub. Date: Sep. 6, 2018

(54) SEE THROUGH AXIAL HIGH ORDER PRISM

(71) Applicant: Intevac, Inc., Santa Clara, CA (US)

(72) Inventor: Michael James Hoppe, Vista, CA (US)

(21) Appl. No.: 15/910,721

(22) Filed: Mar. 2, 2018

Related U.S. Application Data
(60) Provisional application No. 62/466,054, filed on Mar. 2, 2017.

(51) Int. Cl. G02B 5/04; G02B 1/11; G02B 27/01

(52) U.S. Cl. CPC G02B 5/04; G02B 27/0172; G02B 1/11

(57) ABSTRACT

An optical arrangement for a head mounted display, having optical surface that can be described by standard mathematical equations. A prism element is used having three optical surfaces, and wherein the reference surface of the three optical surfaces are centered at, and have no tilt, relative to the optical axis. The prism has first surface that faces the display device and comprises a high order polynomial surface with a reference plane orthogonal to the optical axis. All of the surfaces of the prism are described by extended polynomials defined on a Cartesian coordinates having the z-axis coinciding with the optical axis.

### RELATED APPLICATION

This application claims priority benefit from U.S. Provisional Patent Application No. 62/466,054, filed on Mar. 2, 2017, the entire content of which is incorporated herein by reference.

### BACKGROUND

### 1. Field

This disclosure relates to optical devices and, particularly, to optical arrangement for head-mounted optical devices that enable display of images in virtual reality and mixed reality applications.

### 2. Related Art

Head mounted displays (HMD) can be used for presenting images to a user in a virtual reality and mixed reality applications. In virtual reality the user can view only images that are projected on a flat panel display, while in mixed reality the user can simultaneously view images projected on the flat panel display device and the real environment. Mixed reality applications can include, e.g., providing the user with relevant data as the user views the real environment or superimposing night or thermal vision images over the real environment view. A well-known mixed reality head mounted display is the Google Glass, first released in 2013.

Since head mounted display are worn by the user, they must be small and light. Consequently, the flat panel display mounted within the HMD is also very small; however, the user needs to perceive the image as if it is larger in order to be able to decipher the image displayed. Therefore, the optical arrangement must magnify the image of the flat panel display, while also having wide viewing angle for viewing the environment. Thus, the optical arrangement should preferably embody high performance using a low-cost single optical element.

These stringent requirements led developers to using prisms as the optical arrangement for such head mounted displays, whether for virtual reality of mixed reality. For example, U.S. Pat. No. 6,384,983 to Yamazaki discloses a see through prism having complex surfaces, especially a top surface that has positive power in between regions of negative power. The corrector prism surfaces are decentered. Similarly, U.S. Pat. No. 9,239,453 to Cheng discloses a prism having three free form surfaces. While such prisms may be effective in magnifying and projecting the image, making prisms with complex and free-form surfaces complicates the production and increases the price of the optical arrangement.

The following are some of the issues that may complicate manufacturing the design of the prism and any related optical elements utilizing freeform surfaces. The first, being the fact that the surface cannot be described using typical rotationally symmetric spherical mathematical equation, thus requiring some other method of describing the surface, e.g., a collection of numerical points. If the surface cannot be described by typical rotationally symmetric spherical mathematical equation, it becomes more difficult to generate the path for the CNC tool to grind the surface. Consequently, such surface may also not have a reference surface for alignment or checking. Finally, complex freeform surfaces cannot typically be measured by standard interferometry techniques.

Therefore, there's a need for an optical arrangement for a head mounted display that is small, light, and easy to manufacture.

### SUMMARY

The following summary is included in order to provide a basic understanding of some aspects and features of the invention. This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

Aspects of the invention provide a single optical element that uses three distinct surfaces to form an image. In addition, a secondary element can be used in conjunction with the primary element to allow the system to be used in a see-though application. As such, the optical arrangement can be used in mixed reality application, enabling simultaneous viewing of the environment and a superimposed image from a display device.

Applications for the disclosed optical elements are for near-eye display systems; however, the design form can be utilized in other applications.

Aspects of the invention provide an optical arrangement for a head mounted display, having optical surface that can be described by standard mathematical equations. According to disclosed embodiments, a prism element is used having three optical surfaces, and wherein the reference planes of the surface forms of the three optical surfaces are centered at, and have no coordinate tilt, relative to the optical axis. That is, for the three surfaces, the reference plane is the x-y plane that is orthogonal to and is centered, i.e., has its origin, on the optical axis, which is the z-axis. In one disclosed embodiment, the prism has first surface that faces the display device and comprises a high order polynomial surface with a reference plane orthogonal to the optical axis. In one embodiment, all of the surfaces of the prism are described by extended polynomials defined on a Cartesian coordinates having the optical axis as the z-axis.

Aspects of the invention provide a prism for an optical apparatus, the optical apparatus having a viewing pupil and defining an optical axis through the viewing pupil, wherein the prism comprises: three optical surfaces, wherein surface form of the three optical surfaces are formed to have reference plane centered at, and have no tilt, relative to the optical axis when said prism is installed in the optical apparatus; and, when said prism is installed in the optical apparatus, a first surface of the three optical surfaces faces a display device and comprises a high order extended polynomial surface with a reference plane orthogonal to the optical axis.

Disclosed aspects include an optical arrangement for use in an optical see-through head-mounted display defining an optical axis, comprising a prism having: a first surface configured to receive light from a micro-display and configured to transmit the received light into the body of the prism; a second surface configured to receive the light transmitted into the body of the prism from the first surface and configured to totally internally reflect the received light at the second surface; and, a third surface configured to receive the light reflected by the second surface and configured to reflect the light out of the prism towards a pupil of the head-mounted display; wherein each of the first, second and third optical surfaces is formed as high order extended polynomial, having a reference plane that is centered with respect to the optical axis, and has no tilt with respect to the optical axis. Optionally, the surfaces of the prism may be formed to introduce optical magnification to an image entering the first surface and exiting the second surface.

Further aspects provide a method for forming optical elements for a head mounted display (HMD) according to an embodiment of the invention is as follows. The method starts by defining an optical axis as a straight line from a pupil of the HMD to an aperture of the HMD. In this context the pupil of the HMD is image point which is the eye position of a user viewing the images of the HMD, while the aperture is the opening (not necessarily an aperture stop) through which light from the environment enters the interior of the HMD, thereby enabling the user to view the environment thorough the HMD. A primary prism is then fabricated by forming a first surface configured to face a micro-display installed in the interior of the HMD, the forming of the first surface is performed by defining the surface form of the first surface by a high order expanded polynomial having a reference plane centered on and orthogonal to the optical axis; forming a second surface configured to face the pupil, the forming of the second surface is performed by defining the surface form of the second surface by a high order expanded polynomial having a reference plane centered on and orthogonal to the optical axis; and forming a third surface configured to face the aperture, the forming of the third surface is performed by defining the surface form of the third surface by a high order expanded polynomial having a reference plane centered on and orthogonal to the optical axis. The method may further include offsetting the origin of the reference plane first surface in a direction away from the pupil and at a position along the optical axis and external to the prism. The method may further comprise forming a corrector lens, the corrector lens having a first surface configured to face the third surface of the prism and having a second surface configured to face the aperture, wherein the first and second surfaces of the corrector lens are formed by defining the surface form of the first and second surfaces by a high order expanded polynomial having an origin centered on the optical axis and a reference plane orthogonal to the optical axis. The corrector lens is configured to minimize see through power and distortion through the combination of the primary prism and corrector lens along the optical axis. Consequently, the environment image viewed through the HMD has no magnification and the image of the environment does not appear distorted. In the method, the primary prism may be adhered/bonded to the corrector lens. Alternatively, the primary prism and corrector lens may be held together mechanically.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic illustration of a see-through axial high order prism according to an embodiment of the invention.

FIG. 2 illustrates the see-through axial high order prism according to an embodiment of the invention, indicating the origin for each high order polynomial surface.

FIG. 3 illustrates the see-through head mounted display according to an embodiment of the invention, showing the prism and corrector lens installed within the housing.

FIG. 4 illustrates an embodiment for a virtual reality goggles, utilizing the primary prism without a corrector lens.

### DETAILED DESCRIPTION

The various aspects of the present invention provide for optical arrangement for head mounted display. The disclosed embodiments illustrate various features, such as the mathematical expression for the surface forms of a prism, orientation of the reference plane for the surface forms, the use of a corrector lens, etc. While some of the illustrated embodiments use more than one feature, it should be understood that the features can be implemented independently or in different combinations with various systems.

Embodiments disclosed herein include a head mounted display (HMD), comprising: a housing having an opening for projecting an image at a pupil location; a micro-display mounted inside the housing; and a prism mounted inside the housing, the prism having three surfaces, a first surface facing the micro-display, a second surface facing the single opening, and a third surface; wherein the first, second and third surfaces have a surface form defined by a first, second and third high order expanded polynomials, respectively, each of the high order expanded polynomials having a reference surface which is centered and have no tilt with respect to an optical axis, and wherein the optical axis passes through the single opening and the pupil location. Each of the high order expanded polynomials includes at a minimum up to a fourth order term and may include up to the twentieth order term, while typically including up to the tenth order term. When the HMD is configured for virtual reality, with no see-through capabilities, the third surface includes a mirror coating. When the HMD is configured with see-through capabilities, the housing is provided with an aperture at a location opposite the opening, and the HMD further comprises a corrector lens having a first surface abutting the third surface of the prism, and a second surface facing the aperture, wherein the first and second surfaces of the corrector lens have a surface form defined by high order expanded polynomials, each of the high order expanded polynomials having a reference surface which is centered and have no tilt with respect to an optical axis. For all of the reference surfaces, the z-axis coincides with the optical axis.

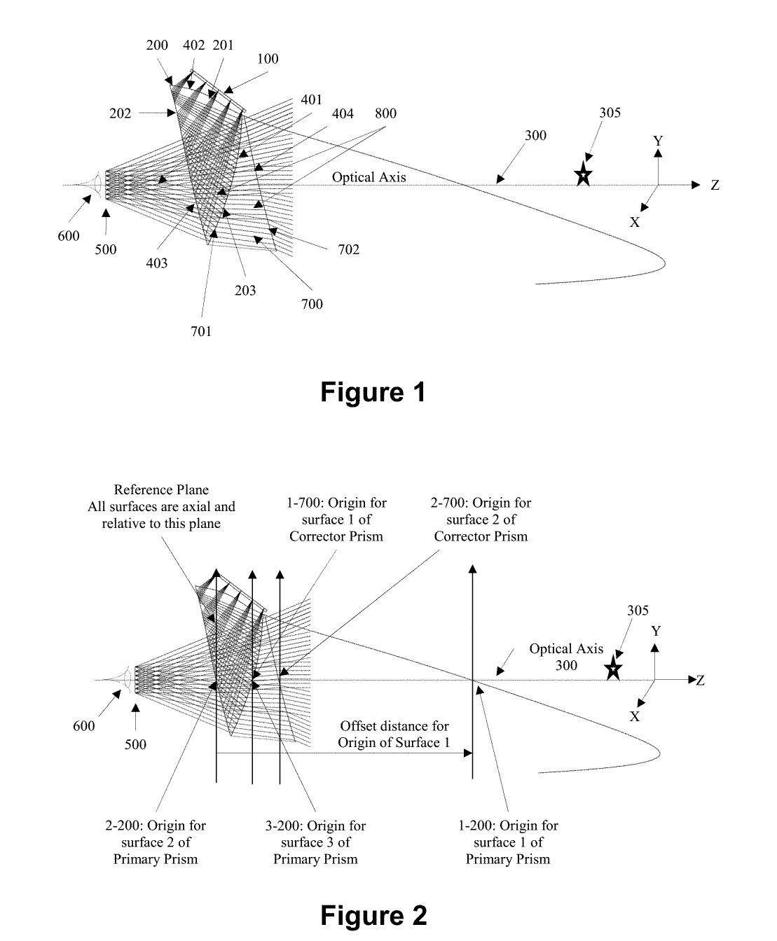

FIG. 1 illustrates an embodiment of the invention, which consists of a primary optical element, here a prism (200) having three surfaces, a pupil 500 for viewing from an eye point (600), and a display, e.g., a flat panel display, (100). The display (100) is mounted at a specific location relative to the primary element (200). Light from the display refracts into the primary element (200) through the first surface (201). The first surface is defined as the surface that faces the display 100. This surface is uniquely described by a high order extended polynomial with a reference plane orthogonal and axial to the optical axis (300). The reference planes of all three optical surfaces of the primary prism (200) are described without decenter and/or tilt relative to the optical axis (300). That is, the surface form formed by the high order extended polynomial of the three optical surfaces of the primary prism (200) have reference planes centered at, and have no tilt, relative to the optical axis (300), thus making it easier to describe, manufacture, and inspect each surface. In this embodiment, the surface forms of the three surfaces are symmetric about the YZ-plane, wherein the Z-axis coincides with the optical axis. The surfaces of the prism may be formed to introduce optical magnification to an image entering the first surface from the display 100, and exiting the second surface towards the pupil 500.

In disclosed embodiments, all of the surfaces of the prism are described by a high order extended polynomial derived in Cartesian coordinates having the z-axis coinciding with the optical axis and reference planes in parallel with the x-y plane. The full functional form of the extended polynomial can be described as:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

where N is the number of polynomial coefficients in the series, and Ai is the coefficient on the i^{th} extended polynomial term Eᵢ(x,y). The polynomials are a power series of x and y, which is arranged in order from the first degree term x and y, followed by 2^{nd} degree terms x², xy, y², and so on. In disclosed embodiments the traditional portion of the sag function may be ignored, so that the sag of each surface can be defined by the polynomial portion only:

z=Σᵢ₌₁^{N}AᵢEᵢ(x,y)=A₁x+A₂y+A₃x²+A₄xy+A₅y²+ . . .

In this disclosure, the term high-order polynomial refers to employing this extended polynomial expression for at least the 4^{th} order terms. However, much improved results can be obtained by utilizing up to, and including, a 10^{th} order terms. In some embodiments the extended polynomial expression is carried to the 20^{th} order term. In this sense, it can be considered that a fourth order is the minimum expansion and it can be expanded up to a maximum of the twentieth term, in even increments, while a typical expansion would be to a tenth term, It should be noted, however, that some of the terms are zeroed in the polynomial. Since in the disclosed embodiments the system is symmetric about one plane, the odd terms in one direction are, by default, zero.

Light that is refracted from the first surface (201) is then Totally Internally Reflected (TIR) from the second surface (202). The second surface is defined as the surface facing the pupil 500 and the viewing eye 600. Light then propagates to the third surface (203) and is reflected via a reflective coating (401) applied to that surface. The third surface is defined as the surface that faces the environment, away from the pupil 500 and the viewing eye 600. Upon reflection, light propagates towards the second surface (202) where it now refracts through the surface towards the viewing or exit pupil (500). At the viewing or exit pupil 500 is where the user would located the eye (600). To optimize performance, the primary embodiment would utilize anti-reflection coating (402) on the first surface (201) and anti-reflection coating (403) second surface (202).

If the coating (401) on third surface (203) is a partial mirror, then the user can see through the two prism surfaces formed by third surface (203) and the second surface (202); however, the user will see a distorted view due to the wedge shape in the primary element (200). To compensate for the introduced wedge in the see-through path, an additional corrector lens or prism (700) is joined to the primary prism (200) in the primary embodiment. The corrector lens (700) consists of two optical surfaces. The first surface (701) is the same or similar in form with the primary prism (200) third surface (203). The second surface 702 of the corrector lens 700 faces away from the pupil 500. Both surfaces of the corrector lens (700) are again described by an axial high order polynomial surface with a reference plane orthogonal to the optical axis (300). Again reference planes of these surfaces are described without decenter and tilt relative to the optical axis. The second surface (702) of the corrector lens (700) allows for the compensation of the optical path when viewing through the prism pair (800) and is designed so that no magnification is introduced into the optical path of the optical axis by the combined primary and corrector elements. Of course, magnification may be introduced by the primary element over the optical path from the display device to the pupil.

FIG. 2 illustrates the see-through axial high order prism according to an embodiment of the invention. As illustrated in FIG. 2, the optical axis is defined as the straight-line axis from the viewing eye 600 and pupil 500, straight through the optical arrangement, and out exiting the aperture to the environment in front of the viewer. Stated another way, the optical axis is defined as if the viewing eye 600 was to look at an object 305 straight through the pupil 500 without any other optical elements. Thus, the optical elements 200 and 700 are designed such that deviation the straight line optical view from the viewing eye 600, through the pupil 500 and to an object 305 in the environment are minimized. Then for defining all of the surfaces of the optical elements this optical axis defines the z-axis for Cartesian coordinates.

The illustration of FIG. 2 indicates the origin for each high order polynomial surface of elements 200 and 700. As illustrated in FIG. 2, the origin for each high order polynomial surface of the primary prism 200 and of the correction prism 700 is centered on, or axial to, the optical axis 300. Also, the reference planes (i.e., x-y plane) of each of the high order polynomial surfaces is orthogonal to the optical axis, i.e., none of the reference planes have tilt with respect to the optical axis. The extended polynomial describing the sag of each surface of both prisms is defined on Cartesian coordinates wherein the z-axis coincides with the optical axis and the origin of each Cartesian coordinates of each surface lies on the intersection of the optical axis and the corresponding x-y plane for the reference plane of a particular surface.

Also shown in FIG. 2 is the global origin of the primary prism, which in this embodiment coincides with the origin of the second surface of the primary prism. All other reference surfaces can be described by an offset from the global origin along the optical axis (in this embodiment, the offset of surface 2 being equal to zero). For example, the origin of the reference plane 1-200 for the first surface is translated along the optical axis in the direction away from the pupil. In the particular embodiment illustrated in FIG. 2, the order of offset away from the eye 600 is as follows: global origin, which coincides with the origin 2-200 for the reference plane of the second surface 202 of the primary prism, then offset 3-200 for the origin for the third surface 203 of primary prism 200, which coincides (albeit may have slight offset due to adhesive between the surfaces) with origin 1-700 for first surface 701 of corrector prism 700, then origin 2-700 for second surface 702 of corrector prism 700, and then origin 1-200 for first surface 201 of the primary prism 200. Notably, the origin 1-200 for the first surface 201 of the prism 200 is translated along the optical axis to a position external to the prism. That is, the first surface 201 of the primary prism is designed such that when the prism is installed in the HMD, the optical axis does not pass through the first surface 201. Consequently, the origin 1-200, and by definition the reference plane of the first surface 201, are translated along the optical axis to a position that may be exterior to the prism. Conversely, since the optical axis passes through all of the other surfaces, this embodiment is designed such that the origins 2-200, 3-200, 1-700 and 2-700 are all at an intersection of the optical axis with the respective surface of the respective prism.

In the embodiment illustrated in FIG. 2, all of the reference surfaces of the primary prism 200 and corrector prism 700 are axial and have no tilt with respect to the optical axis. All of the surfaces are described by a high order extended polynomial which has its origin lying in the area between a reference plane positioned at the global origin of the primary prism, and which is closest to the exit pupil 500, and a plane coinciding with the origin of the first surface of the primary prism. All of the reference surfaces are parallel with the reference plane, which is itself orthogonal to the optical axis 300. Each lens surface is defined by a minimum of fourth order extended polynomial term and up to and including a tenth or a twentieth order extended polynomial term, wherein all of the extended polynomials are defined on a Cartesian coordinate system having an origin on the optical axis which defines the z-axis, and x-y plane orthogonal to the optical axis.

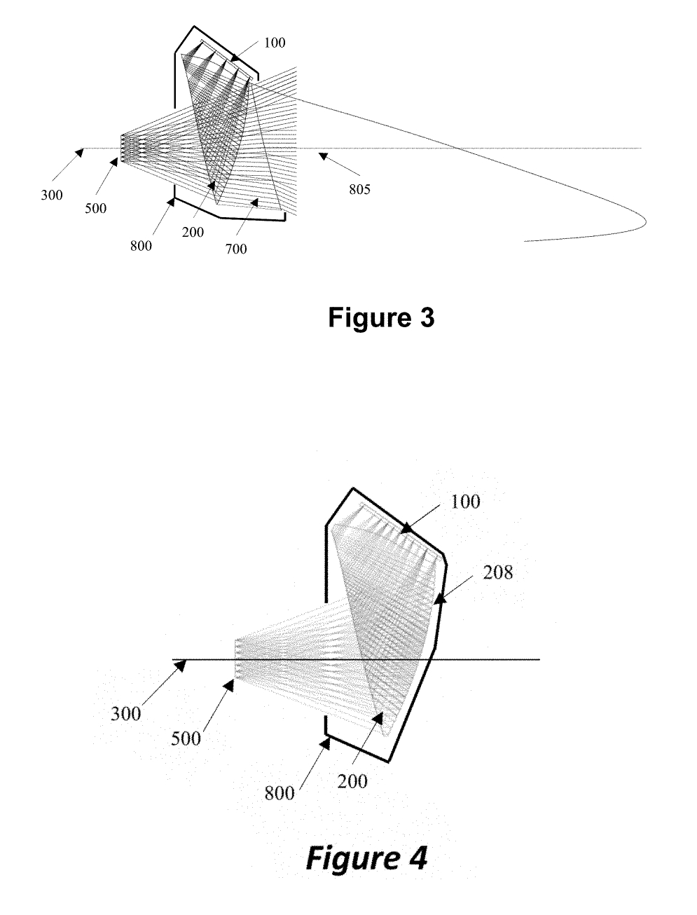

FIG. 3 illustrates the see-through head mounted display according to an embodiment of the invention, showing the prism 200 and corrector lens 700 installed within the housing 800. The optical axis is defined as a straight line from the viewing pupil 500 to the aperture 805. A micro-display 100 is mounted in the housing 800, such that the first surface of the prism 200 faces the micro-display 100. The micro-display may be, e.g., a CCD, an LED or OLED, a flat or a curved screen, etc.

A method for fabricating a HMD according to an embodiment of the invention includes fabricating a housing having a viewing port and an aperture; attaching a micro-display in the housing; and installing a primary prism and a corrector prism inside the housing. The method includes the steps of designing the primary prism and corrector prism such that distortions and magnification along the optical axis are minimized, while images projected from the micro-display towards the viewing port are magnified. The method for making the primary and corrector prisms can follow any of the embodiments described herein. The primary prism and corrector prism are installed inside the housing such that a first surface of the primary prism faces the micro-display. In one embodiment the primary prism is adhered to the corrector prism, while in other embodiments the primary prism and corrector prism are held together mechanically within the housing. The method may include providing a half mirror coating to a second and/or a third surface of the primary prism. The method may further include providing an AR coating on one or both surfaces of the corrector prism.

A method for forming optical elements for a head mounted display (HMD) according to an embodiment of the invention is as follows. The method starts by defining an optical axis as a straight line from a pupil (or viewing port) of the HMD to an aperture (light entrance) of the HMD. A prism is then fabricated by forming a first surface configured to face a micro-display installed in the HMD, the forming of the first surface is performed by defining the surface form of the first surface by a high order expanded polynomial having an origin centered on the optical axis and a reference plane orthogonal to the optical axis; forming a second surface configured to face the pupil, the forming of the second surface is performed by defining the surface form of the second surface by a high order expanded polynomial having an origin centered on the optical axis and a reference plane orthogonal to the optical axis; and forming a third surface configured to face the aperture, the forming of the third surface is performed by defining the surface form of the third surface by a high order expanded polynomial having an origin centered on the optical axis and a reference plane orthogonal to the optical axis. The method may further include offsetting the origin of the first surface in a direction away from the pupil and at a position along the optical axis external to the prism. The method may further comprise forming a corrector lens, the corrector lens having a first surface configured to face the third surface of the prism and having a second surface configured to face the aperture, wherein the first and second surfaces of the corrector lens are formed by defining the surface form of the first and second surfaces by a high order expanded polynomial having an origin centered on the optical axis and a reference plane orthogonal to the optical axis. The method may further include forming all the surfaces of the primary prism and corrector lens symmetrical about a Y-Z plane, wherein the Z-axis coincides with the optical axis and the Y-axis corresponds to any of the reference planes.

In all of the embodiments described above, the primary lens and corrector lens may be held in close proximity or in physical contact by mechanical means, such as being mechanically held by the housing, or they may be adhered together. In a case where the prisms are mechanically held, an air gap may form between the third surface of the primary prism and the first surface of the corrector prism. To minimize distortions that may be cause by such an air gap, an anti-reflective coating should be provided on the third surface of the primary prism and the first surface of the corrector lens. In embodiments where the primary lens and the corrector lens are adhered together, no air gap exists and no AR coating is needed on the bonded surfaces.

FIG. 4 illustrates an embodiment for virtual reality, wherein no see-through capability is provided. Notably, the housing 800 in the embodiment of FIG. 4 has no aperture to receive light from the environment. Only opening provided in the housing 800 is for the projecting the image from the micro-display 100 onto the pupil 500. Since no see-through capability is provide, no corrector lens is needed. Rather, only the primary prism 200 is situated inside the housing 800, having its first surface facing the micro-display, as in the other disclosed embodiments. Also, since the primary prism need not enable see through capability, it is beneficial to coat the third surface with a full mirror coating 208. An anti-reflection coating may be provided on the first and/or second surface, as in the embodiment of FIG. 1.

Thus, according to the embodiment of FIG. 4, a head mounted display is provided, comprising: a housing having a single opening for projecting an image; a micro-display mounted inside the housing; a prism mounted inside the housing, the prism having three surfaces, a first surface facing the micro-display, a second surface facing the single opening, and a third surface having a mirror coating, wherein the first, second and third surfaces have a surface form defined by a first, second and third high order expanded polynomials, respectively, each of the high order expanded polynomials having a reference surface which is centered and have no tilt with respect to an optical axis, and wherein the optical axis passes through the single opening.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A prism for an optical apparatus, the optical apparatus having a viewing pupil and defining an optical axis through the viewing pupil, wherein the prism comprises:
three optical surfaces, wherein the surface form of the three optical surfaces are formed to have the origin centered at the optical axis when said prism is installed in the optical apparatus; and,
when said prism is installed in the optical apparatus, a first surface of the three optical surfaces faces a display device and comprises a high order extended polynomial surface with a reference plane orthogonal to the optical axis.

2. The prism of claim 1, wherein each of the three optical surfaces is formed as axial high order extended polynomials.

3. The prism of claim 1, wherein each of the high order extended polynomial is derived in Cartesian coordinates having a z-axis coinciding with the optical axis.

4. The prism of claim 1, wherein origin of the first surface is translated along the optical axis in the direction away from the viewing pupil.

5. The prism of claim 4, wherein origin of second surface of the three surfaces is at the intersection of the second surface and the optical axis, and the origin of the third surface of the three surfaces is at the intersection of the third surface and the optical axis.

6. The prism of claim 1, wherein a third surface of the three surfaces includes a full or partial mirror coating.

7. The prism of claim 6, wherein the three surfaces are symmetric along an YZ-plane, wherein Z-axis of the YZ-plane coincides with the optical axis and Y-axis of the YZ-plane is orthogonal to the optical axis.

8. The prism of claim 3, wherein each of the three optical surfaces is formed as axial high order extended polynomials extended at least to a fourth order term.

9. The prism of claim 3, wherein each of the three optical surfaces is formed as axial high order extended polynomials extended to from a fourth order term up to a twentieth order term in even increments.

10. The prism of claim 3, further comprising anti-reflection coatings on at least one of the first surface and second surface.

11. An optical arrangement configured to be installed in an optical see-through head-mounted display defining an optical axis, comprising:
a prism having:
a first surface configured to receive light from a micro-display and configured to transmit the received light into the body of the prism;
a second surface configured to receive the light transmitted into the body of the prism from the first surface and configured to totally internally reflect the received light at the second surface; and
a third surface configured to receive the light reflected by the second surface and configured to reflect the light out of the prism towards a pupil of the head-mounted display;
wherein each of the first, second and third optical surfaces is formed as high order extended polynomial, having reference plane that is centered with respect to the optical axis, and has no tilt with respect to the optical axis.

12. The optical arrangement of claim 11, wherein origin of the first surface is translated along the optical axis in the direction away from a viewing pupil at a position external to the prism.

13. The optical arrangement of claim 11, wherein each of the first, second and third optical surfaces is symmetric along a YZ-plane, wherein Z-axis of the YZ plane coincides with the optical axis.

14. The optical arrangement of claim 11, wherein each of the first, second and third optical surfaces is formed as axial high order extended polynomials extended at least to a fourth order term.

15. The optical arrangement of claim 11, wherein each of the first, second and third optical surfaces is formed as axial high order extended polynomials extended at least to from a fourth order term to a twentieth order term in even increments.

16. The optical arrangement of claim 11, further comprising a corrector lens having a first surface shaped to mate with the third surface of the prism and a second surface facing away from the pupil.

17. The optical arrangement of claim 16, wherein the first and second surfaces of the corrector lens are defined by an axial high order polynomial surface with a reference plane orthogonal to the optical axis.

18. The optical arrangement of claim 17, further comprising anti-reflection coatings on at least one of the surfaces of the prism and the corrector lens.

19. A method for forming optical elements for a head mounted display (HMD) comprising:
defining an optical axis as a straight line from a pupil of the HMD to an aperture of the HMD;
fabricating a prism by forming a first surface configured to face a micro-display installed in the HMD, the forming of the first surface is performed by defining the surface form of the first surface by a high order expanded polynomial having an origin centered on the optical axis and a z-axis coinciding with the optical axis; forming a second surface configured to face the pupil, the forming of the second surface is performed by defining the surface form of the second surface by a high order expanded polynomial having an origin centered on the optical axis and a z-axis coinciding with the optical axis; and forming a third surface configured to face the aperture, the forming of the third surface is performed by defining the surface form of the third surface by a high order expanded polynomial having an origin centered on the optical axis and a z-axis coinciding with the optical axis.

20. The method of claim 19, further comprising offsetting the origin of the first surface in a direction away from the pupil and at a position external to the prism along the optical axis.

21. The method of claim 20, further comprising forming a corrector lens, the corrector lens having a first surface configured to face the third surface of the prism and having a second surface configured to face the aperture, wherein the first and second surfaces of the corrector lens are formed by defining the surface form of the first and second surfaces by a high order expanded polynomial having an origin centered on the optical axis and a z-axis coinciding with the optical axis.
